(19) United States
(12) Patent Application Publication
(10) Pub. No.: US 2012/0215837 A1
(43) Pub. Date: Aug. 23, 2012

(54) NETWORK DEVICE AND FILE TRANSFER METHOD

(75) Inventors: Satoru GOTO, Nagoya-shi (JP); Yukihito HARA, Nagoya-shi (JP)

(73) Assignee: Buffalo Inc., Nagoya-shi (JP)

(21) Appl. No.: 13/362,080

(22) Filed: Jan. 31, 2012

(30) Foreign Application Priority Data
Jan. 31, 2011 (JP) 2011-019252

(51) Int. Cl. G06F 15/16

(52) U.S. Cl. 709/203

(57) ABSTRACT

A network device that includes a server-side specific functional unit which has a function to manage a location of a data file in accordance with a specific file sharing function; a client-side specific functional unit which has a function to acquire the data file in accordance with the specific file sharing function; a server-side general functional unit which has a function to manage the location of the data file in accordance with a general file sharing function; and a client-side general functional unit which has a function to acquire the data file in accordance with the general file sharing function.

### CROSS REFERENCE TO RELATED APPLICATIONS

This application is based upon and claims the benefit of priority from prior Japanese Patent Application No. 2011-019252, filed on Jan. 31, 2011, the entire content of which is incorporated herein by reference.

### BACKGROUND OF DISCLOSURE

1. Technical Field

The present disclosure relates to a network device and a file transfer method for communicating with a device having a general file sharing function and a specific file sharing function.

2. Description of the Related Art

Recently, a communication system has been developed that transfers data files via a network established between terminals in order to share the data file between the terminals. Such a communications system requires a specific file sharing function (i.e., a specific file sharing protocol) for sharing the data file.

For example, a case in which the data file is shared between network devices will be described. One network device is provided with a client-side specific functional unit having a function to acquire the data file and the other network device is provided with a server-side specific functional unit having a function to manage a location of the data file.

There is, however, a need to share the data file with a network device which is provided with no specific file sharing function. It is considered that a terminal which has no user interface, such as the Network Attached Storage (NAS), is used as a network device. It is also considered, in such a case, that providing a specific file sharing function in network device is difficult.

### SUMMARY

A network device according to a first feature of the present disclosure includes: a server-side specific functional unit which has a function to manage a location of data file in accordance with a specific file sharing function; a client-side specific functional unit which has a function to acquire the data file in accordance with the specific file sharing function; a server-side general functional unit which has a function to manage the location of the data file in accordance with a general file sharing function; and a client-side general functional unit which has a function to acquire data file in accordance with the general file sharing function. The server-side general functional unit requests the client-side general functional unit to acquire data file, via the server-side specific functional unit and the client-side specific functional unit. The client-side general functional unit acquires the data file requested by the server-side general functional unit, from another network device. The server-side specific functional unit and the client-side specific functional unit are connected to each other by a virtual network established inside the network device.

According to the first feature, a virtual network address used within the network device is allocated to the server-side specific functional unit and the client-side specific functional unit in order to establish the virtual network.

According to the first feature, the server-side general functional unit requests the client-side general functional unit to acquire data file, via the server-side specific functional unit and the client-side specific functional unit, if the another network device does not have the specific file sharing function.

According to the first feature, the server-side general functional unit inquires of the server-side specific functional unit about a location of the data file if the another network device has the specific file sharing function. The server-side specific functional unit requests the client-side specific functional unit to acquire the data file requested by the server-side general functional unit; and the client-side specific functional unit acquires the data file requested by the server-side general functional unit, from the another network device.

According to the first feature, the data file shared with the specific file sharing function or the general file sharing function are fragmented and stored in multiple other network devices; and real addresses of the data file fragmented and stored in the multiple other network devices are correlated with a local address used within the network device.

A file transfer method according to a second feature is applied for a network device comprising a server-side specific functional unit which has a function to manage a location of data file in accordance with a specific file sharing function; a client-side specific functional unit which has a function to acquire the data file in accordance with the specific file sharing function; a server-side general functional unit which has a function to manage the location of the data file in accordance with a general file sharing function; and a client-side general functional unit which has a function to acquire data file in accordance with the general file sharing function. The file transfer method includes the steps of: requesting the client-side general functional unit to acquire data file from the server-side general functional unit, via the server-side specific functional unit and the client-side specific functional unit; transmitting the data file requested by the server-side general functional unit, from another network device to the client-side general functional unit; and transmitting the data file received from the another network device, from the client-side general functional unit to the server-side general functional unit. The server-side specific functional unit and the client-side specific functional unit are connected to each other by a virtual network established inside the network device.

### BRIEF DESCRIPTION OF THE DRAWINGS

FIG. 1 shows a network configuration according to a first embodiment.

FIG. 2 shows a block diagram of a server terminal 20 according to the first embodiment.

FIG. 3 shows a first example of acquiring data file according to the first embodiment.

FIG. 4 shows a second example of acquiring the data file according to the first embodiment.

FIG. 5 shows a network according to a first example.

FIG. 6 shows a setting screen according to the first example.

FIG. 7 shows a directory configuration according to the first example.

FIG. 8 shows a storage area according to the first example.

FIG. 9 shows an exemplary hardware configuration according to the first embodiment and/or the first example.

### DETAILED DESCRIPTION OF THE EMBODIMENTS

Hereinafter, a network device related to an embodiment of the present disclosure will be described with reference to the drawings. Through the all drawings, identical or similar components are denoted by identical or similar reference numerals.

It should be understood that the drawings are schematic for understanding the specification, the scales of elements and the ratios between the elements are not actual ones.

### Outline of Embodiment

A network device according to embodiments of the present disclosure includes: a server-side specific functional unit which has a function to manage a location of data file in accordance with a specific file sharing function; a client-side specific functional unit which has a function to acquire the data file in accordance with the specific file sharing function; a server-side general functional unit which has a function to manage the location of the data file in accordance with a general file sharing function; and a client-side general functional unit which has a function to acquire data file in accordance with the general file sharing function. The server-side general functional unit requests the client-side general functional unit to acquire data file, via the server-side specific functional unit and the client-side specific functional unit. The client-side general functional unit acquires the data file requested by the server-side general functional unit, from another network device. The server-side specific functional unit and the client-side specific functional unit are connected to each other by a virtual network established inside the network device.

In the embodiment, the server-side specific functional unit and the client-side specific functional unit are provided in a single network device. Therefore, it is possible to acquire the data file from another network device even if the network device does not have the specific file sharing function.

An example of the specific file sharing function is “Gfarm.” An example of the general file sharing function is “SAMBA.”

A real address of the data file shared with the specific file sharing function or the general file sharing function is correlated with a local address used within the network device.

The data file shared with the specific file sharing function or the general file sharing function may be fragmented and stored in multiple other network devices. In that case, real addresses (i.e., multiple real addresses) of data file fragmented and stored in the multiple other network devices are correlated with the local address (i.e., a single real address) used within the network device.

### First Embodiment

### Network Configuration

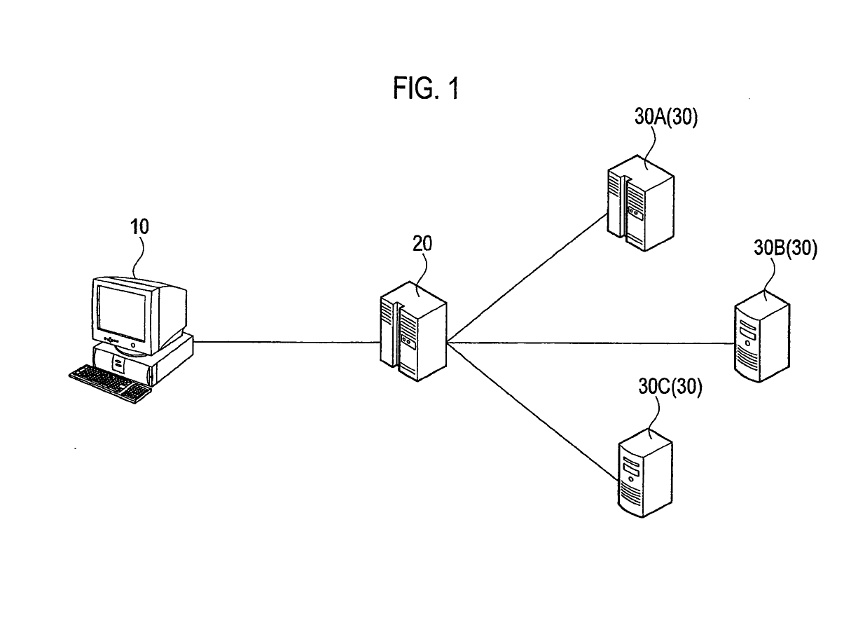

Hereinafter, a network configuration according to a first embodiment will be described with reference to the drawings. FIG. 1 shows the network configuration according to the first embodiment.

As shown in FIG. 1, a network includes a client terminal 10, a server terminal 20 and distributed server terminals 30 (i.e., distributed server terminals 30A to 30C).

The client terminal 10 is a terminal, such as a personal computer. The client terminal 10 is connected to the server terminal 20. Communication protocols, such as Server Message Block (SMB) and Common Internet File System (CIFS), are used between the client terminal 10 and the server terminal 20.

The client terminal 10 has a client-side general functional unit having a function to acquire data file in accordance with a general file sharing function. The general file sharing function is a file sharing function used for general purpose and an example thereof is “SAMBA.”

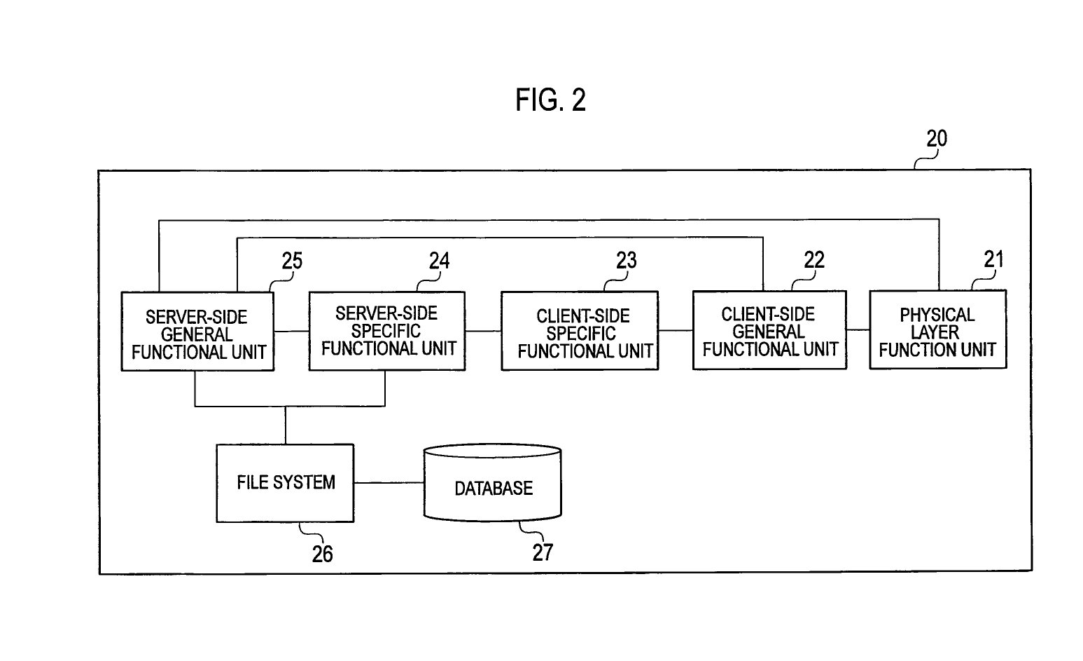

The server terminal 20 is a terminal, such as the Network Attached Storage (NAS), and is an example of a network device. The server terminal 20 is connected to multiple distributed server terminals 30. Communication protocols, such as SMB and CIFS, are used between the server terminal 20 and each of the distributed server terminals 30. Details of the server terminal 20 will be described below (see FIG. 2).

The distributed server terminals 30 are terminals, such as NASs, and are examples of other network devices. For example, the distributed server terminal 30A has a specific file sharing function. The distributed server terminal 30B and the distributed server terminal 30C do not have the specific file sharing function but has only the general file sharing function. An example of the specific file sharing function is “Gfarm.”

As described above, in the first embodiment, the distributed server terminal(s) 30 which has the specific file sharing function and the distributed server terminal(s) 30 which does not have the specific file sharing function coexist.

### (Configuration of Server Terminal)

Hereinafter, a configuration of the server terminal according to the first embodiment will be described with reference to the drawings. FIG. 2 shows a block diagram of the server terminal 20 according to the first embodiment.

As shown in FIG. 2, the server terminal 20 includes a physical layer function unit 21, a client-side general functional unit 22, a client-side specific functional unit 23, a server-side specific functional unit 24, a server-side general functional unit 25, a file system 26 and a database 27.

The physical layer function unit 21 processes a physical layer. In particular, the physical layer function unit 21 communicates with the client terminal 10 and the distributed server terminals 30.

The client-side general functional unit 22 has a function to acquire data file in accordance with the general file sharing function. In particular, the client-side general functional unit 22 acquires data file from other network devices which have the general file sharing function (i.e., the distributed server terminal 30B and the distributed server terminal 30C in the first embodiment) in accordance with the general file sharing function.

The client-side specific functional unit 23 has a function to acquire data file in accordance with the specific file sharing function. In particular, the client-side specific functional unit 23 acquires data file from other network devices which have the specific file sharing function (i.e., the distributed server terminal 30A in the first embodiment) in accordance with the specific file sharing function.

The server-side specific functional unit 24 has a function to manage the location of the data file in accordance with the specific file sharing function. In particular, the server-side specific functional unit 24 manages meta data of a virtual directory hierarchy of the data file in accordance with the specific file sharing function. The server-side specific functional unit 24 manages meta data of a real address of the data file in accordance with the specific file sharing function. Note that the server-side specific functional unit 24 also manages the location of the data file which is managed by other network device(s) that has the specific file sharing function (i.e., the distributed server terminal 30A in the first embodiment).

The server-side general functional unit 25 has a function to manage the location of the data file in accordance with the general file sharing function. In particular, the server-side general functional unit 25 manages the meta data of the virtual directory hierarchy of the data file in accordance with the general file sharing function. The server-side general functional unit 25 manages the meta data of the real address of the data file in accordance with the general file sharing function. Note that the server-side general functional unit 25 also manages the location of the data file which is managed by other network device(s) that has the general file sharing function (i.e., the distributed server terminals 30B and 30C in the first embodiment).

The file system 26 manages the data file stored in the database 27. In particular, the file system 26 provides the client-side general functional unit 22 (or the client-side specific functional unit 23) with the data file stored in the database 27 in response to the request by the client-side general functional unit 22 (or the client-side specific functional unit 23).

The data file is stored in the database 27.

In the first embodiment, the client-side specific functional unit 23 and the server-side specific functional unit 24 are connected to each other by a virtual network established inside the server terminal 20. In particular, a virtual network address used within the server terminal 20 is allocated to each of the client-side specific functional unit 23 and the server-side specific functional unit 24.

### (First Example of Acquiring Data File)

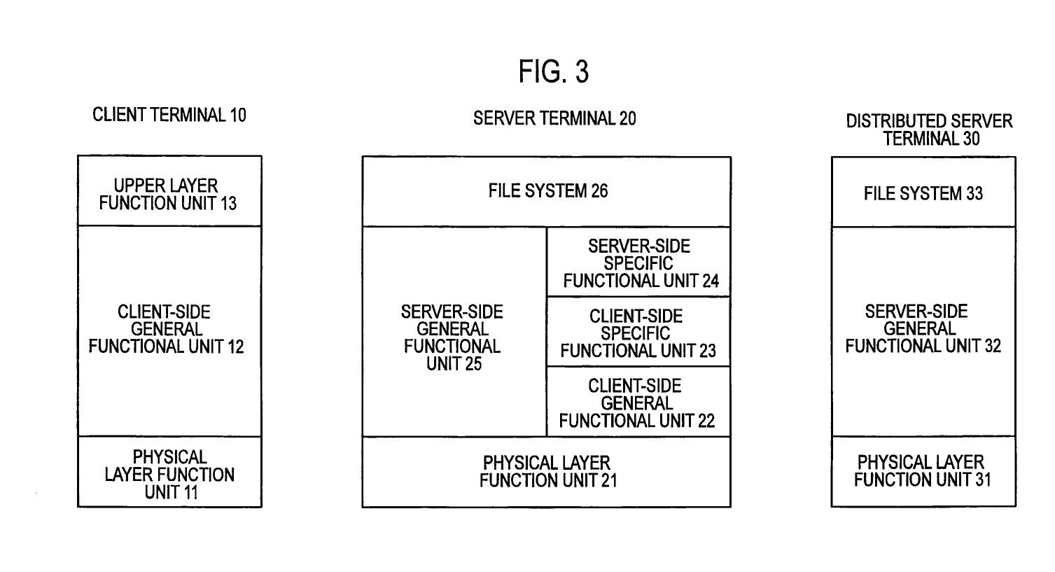

Hereinafter, a first example of acquiring the data file according to the first embodiment will be described with reference to the drawings. FIG. 3 shows a first example of acquisition of data file according to the first embodiment. In particular, the first example of acquiring the data file will be described with reference to a case in which the client terminal 10 acquires the data file from the distributed server terminal(s) 30 which does not have the specific file sharing function (i.e., the distributed server terminals 30B and 30C).

As shown in FIG. 3, the client terminal 10 includes a physical layer function unit 11, a client-side general functional unit 12 and an upper layer function unit 13. The distributed server terminal(s) 30 includes a physical layer function unit 31, a server-side general functional unit 32 and a file system 33.

The functions of the physical layer function unit 11 and the physical layer function unit 31 are the same as that of the physical layer function unit 21; thus description of the physical layer function unit 11 and the physical layer function unit 31 will be omitted. The function of the client-side general functional unit 12 is the same as that of the client-side general functional unit 22; thus description of the client-side general functional unit 12 will be omitted. The function of the server-side general functional unit 32 is the same as that of the server-side general functional unit 25; thus detailed description of the server-side general functional unit 32 will be omitted. The function of the file system 33 is the same as that of the file system 26; thus description of the file system 33 will be omitted. The upper layer function unit 13 controls, for example, an application which runs on the client terminal 10.

(1-1) The client-side general functional unit 12 requests the server-side general functional unit 25 to provide the data file. For example, the client-side general functional unit 12 designates a file name of the data file and requests the data file.

(1-2) The server-side general functional unit 25 refers to the meta data of the virtual directory hierarchy and determines whether the data file requested by the client-side general functional unit 12 is stored in the distributed server terminal(s) 30 which does not have the specific file sharing function. Here, a case in which the data file requested by the client-side general functional unit 12 which does not have the specific file sharing function is stored in the distributed server terminal 30 will be described.

(1-3) The server-side general functional unit 25 requests, via the server-side specific functional unit 24 and the client-side specific functional unit 23, the client-side general functional unit 22 to acquire the data file. As described above, the client-side specific functional unit 23 and the server-side specific functional unit 24 are connected to each other by the virtual network established inside the server terminal 20.

(1-4) The client-side general functional unit 22 requests the server-side general functional unit 32 to provide the data file which has been requested by the client-side general functional unit 12.

(1-5) The server-side general functional unit 32 acquires, from the file system 33, the data file requested by the client-side general functional unit 12 and transmits the data file acquired from the file system 33 to the client-side general functional unit 22.

(1-6) The client-side general functional unit 22 provides, via the server-side general functional unit 25, the client-side general functional unit 12 with the data file acquired from the server-side general functional unit 32.

Although not mentioned in the first example of acquiring the data file, if the data file requested by the client-side general functional unit 12 is stored in the database 27, the server-side general functional unit 25 acquires the data file requested by the client-side general functional unit 12 from the file system 26 (the database 27), and transmits the data file acquired from the file system 26 (the database 27) to the client-side general functional unit 12.

### (Second Example of Acquiring Data File)

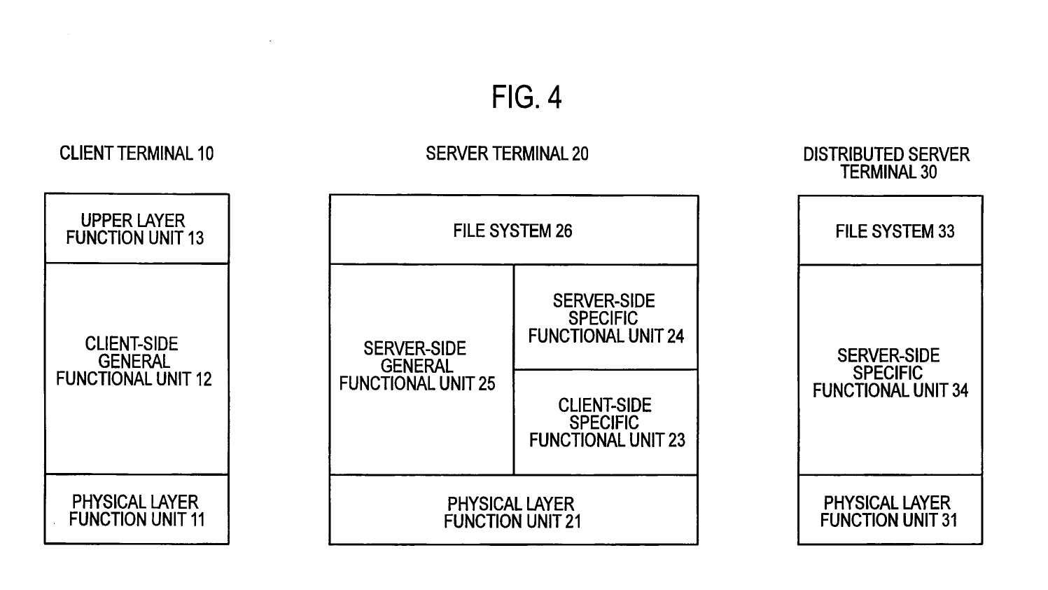

Hereinafter, a second example of acquiring the data file according to the first embodiment will be described with reference to the drawings. FIG. 4 shows a second example of acquiring the data file according to the first embodiment. In particular, the second example of acquiring the data file will be described with reference to a case in which the client terminal 10 acquires the data file from the distributed server terminal(s) 30 which has the specific file sharing function (i.e., the distributed server terminal 30A).

As shown in FIG. 4, the client terminal 10 has the same configuration as that shown in FIG. 3. The distributed server terminal(s) 30 includes a server-side specific functional unit 34 instead of the server-side general functional unit 32 shown in FIG. 3.

The function of the server-side specific functional unit 34 is the same as that of the server-side specific functional unit 24; thus detailed description of the server-side specific functional unit 34 will be omitted.

(2-1) The client-side general functional unit 12 requests the server-side general functional unit 25 to provide the data file. For example, the client-side general functional unit 12 designates a file name of the data file and requests the data file.

(2-2) The server-side general functional unit 25 refers to the meta data of the virtual directory hierarchy and determines whether the data file requested by the client-side general functional unit 12 is stored in the distributed server terminal(s) 30 which does not have the specific file sharing function. Here, a case in which the data file requested by the client-side general functional unit 12 which does not have the specific file sharing function is not stored in the distributed server terminal 30 will be described.

(2-3) The server-side general functional unit 25 inquires of the server-side specific functional unit 24 about a location of the data file.

(2-4) The server-side specific functional unit 24 requests the client-side specific functional unit 23 to acquire the data file. As described above, the client-side specific functional unit 23 and the server-side specific functional unit 24 are connected to each other by the virtual network established inside the server terminal 20.

(2-5) The client-side specific functional unit 23 requests the server-side specific functional unit 34 to provide the data file requested by the client-side general functional unit 12.

(2-6) The server-side specific functional unit 34 acquires, from the file system 33, the data file requested by the client-side general functional unit 12 and transmits the data file acquired from the file system 33 to the client-side specific functional unit 23.

(2-7) The client-side specific functional unit 23 transmits the data file acquired from the server-side specific functional unit 34 to the client-side general functional unit 12 via the server-side general functional unit 25.

Although not mentioned in the second example of acquiring the data file, if the data file requested by the client-side general functional unit 12 is stored in the database 27, the server-side general functional unit 25 acquires the data file requested by the client-side general functional unit 12 from the file system 26 (the database 27), and transmits the data file to the client-side general functional unit 12.

### (Operation and Effect)

In the first embodiment, the client-side specific functional unit 23 and the server-side specific functional unit 24 are provided in a single server terminal 20, and the client-side specific functional unit 23 and the server-side specific functional unit 24 are connected to each other by the virtual network established inside the server terminal 20. The server-side general functional unit 25 requests, via the server-side specific functional unit 24 and the client-side specific functional unit 23, the client-side general functional unit 22 to acquire the data file. Therefore, the data file can be acquired from other network device(s) (i.e., the distributed server terminal(s) 30) even if the network device(s) (i.e., the distributed server terminal(s) 30) does not have the specific file sharing function.

In particular, if other network device(s) (i.e., the distributed server terminal(s) 30) does not have the specific tile sharing function, the server-side general functional unit 25 requests, via the server-side specific functional unit 24 and the client-side specific functional unit 23, the client-side general functional unit 22 to acquire the data file. With this, the data file can be acquired from other network device(s) which only has the general file sharing function (i.e., the distributed server terminals 30B and 30C).

If, on the other hand, other network device(s) (i.e., the distributed server terminal 30) has the specific file sharing function, the server-side general functional unit 25 inquires of the server-side specific functional unit 24 about the location of the data file. With this, the data file can be acquired also from other network device(s) which has the specific file sharing function (i.e., the distributed server terminal 30A).

### First Example

Hereinafter, a first example of the first embodiment will be described. In the first example, an example of operation of the first embodiment will be described with reference to a case in which the specific file sharing function is “Gfarm.” An example of the server terminal herein is the Network Attached Storage (NAS).

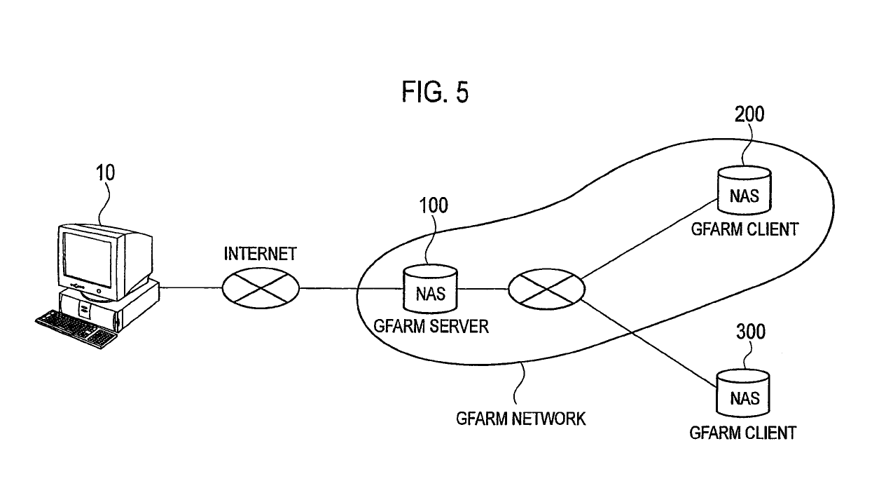

In particular, as shown in FIG. 5, a network communication system includes a client terminal 10, a NAS 100, a NAS 200 and a NAS 300. The NAS 100 is a device which has the Gfarm and corresponds to the server terminal 20 described above. The NAS 200 and the NAS 300 do not have the Gfarm and correspond to the distributed server terminal(s) 30 described above.

In the first example, a Gfarm network is established inside the network described above. Although the NAS 200 and the NAS 300 do not have the Gfarm, but these NASs can participate in the Gfarm network with the function of the NAS 100 (i.e., the server terminal 20). That is, the NAS 100 functions as a Gfarm server and the NAS 200 and the NAS 300 function as Gfarm clients.

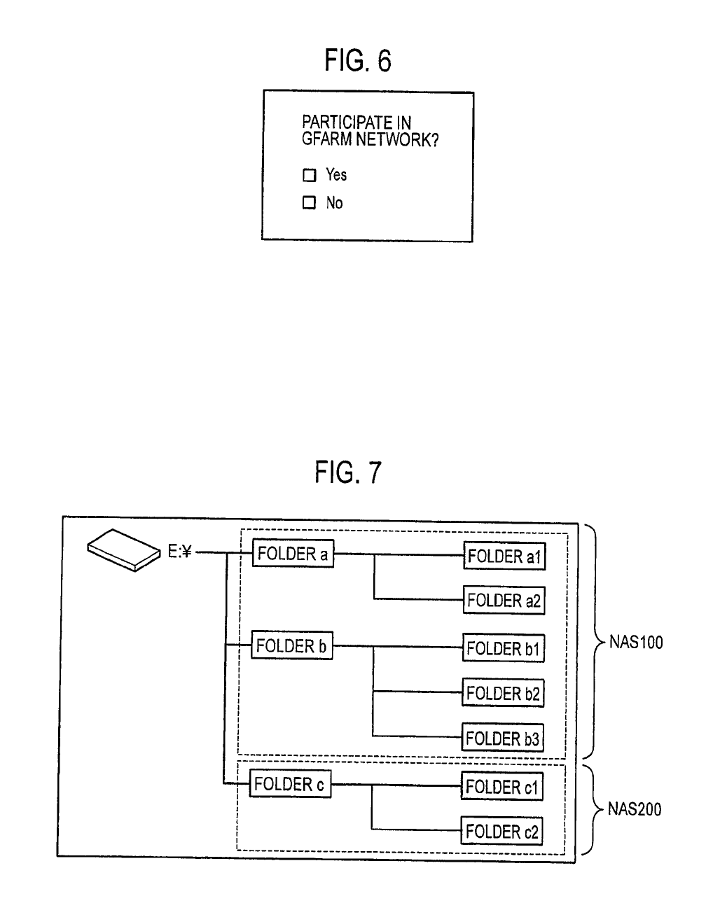

For example, the user can set, on a setting screen shown in FIG. 6, whether the NAS 200 or the NAS 300 participate in the Gfarm network. As shown in FIG. 6, check boxes for selecting “Yes” or “No” are provided on the setting screen. When “Yes” box is checked, the NAS 200 or the NAS 300 participates in the Gfarm network. When “No” box is checked, the NAS 200 or the NAS 300 does not participate in the Gfarm network.

The user sets whether the NAS 200 or the NAS 300 participates in the Gfarm network using a terminal capable of accessing the NAS 200 or the NAS 300. Alternatively, the user may set whether the NAS 200 or the NAS 300 participates in the Gfarm network using the client terminal 10.

In the first example, the user sets the NAS 200 to participate in the Gfarm network and sets the NAS 300 not to participate in the Gfarm network. That is, the Gfarm network is constituted by the NAS 100 and the NAS 200.

Note that the Gfarm client (e.g., the NAS) which participates in the Gfarm network may be previously registered to the Gfarm server.

Here, the client terminal 10 can access the NAS 200 via the NAS 100 (i.e., the server terminal 20). The client terminal 10 acquires a directory configuration shown in FIG. 7 as a directory configuration of the Gfarm network.

As shown in FIG. 7, folders a to c are correlated with a local drive E. The folder a is correlated with folders a1 and a2. The folder b is correlated with folders b1 to b3. The folder c is correlated with folders c1 and c2.

In this directory configuration, entities of the files stored in the folders a1, a2, b1, b2 and b3 are stored in the NAS 100; and entities of the files stored in the folders c1 and c2 are stored in the NAS 200.

Thus, storage areas of the NAS 100 and the NAS 200 are managed as a single storage area (here, the local drive E) without the need of distinction between the NAS 100 and the NAS 200. The storage areas of the NAS 100 and the NAS 200 are recognized by the user as an integrated single storage area (here, the local drive E).

It is also possible to manage a part of the storage areas of the NAS 100 and the NAS 200 as an integrated single storage area (here, the local drive E).

Here, the real addresses of the files stored in the folders a1, a2, b1, b2, b3, c1 and c2 are correlated with local address used within the server terminal 20 (e.g., the local drive E).

The entities of the files stored in the folders a1, a2, b1, b2, b3, c1 and c2 may be fragmented and stored in the NAS 100 and the NAS 200. For example, the entity of the file stored in the folder a1 is fragmented and stored in the NAS 100 and the NAS 200. In this case, multiple real addresses are correlated with a single local address.

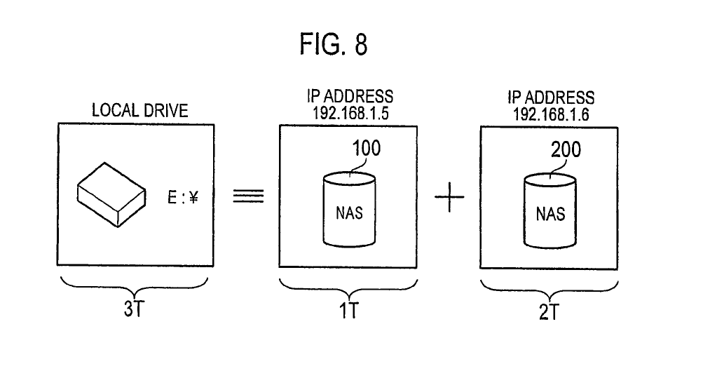

In this manner, the user of the client terminal 10 can consider the storage area of the NAS 100 (e.g., 1 Tbyte) and the storage area of the NAS 200 (e.g., 2 Tbytes) as a single storage area (1 Tbyte+2 Tbytes□3 Tbytes) without the need of distinction between the NAS 100 and NAS 200 as shown in FIG. 8. That is, the user of the client terminal 10 recognizes that storage capacity of the local drive E is substantially 3 Tbytes. Note that, since it is necessary to secure the storage capacity required to use the Gfarm, the storage capacity of the file is slightly smaller than the total storage capacity of the NAS 100 and the NAS 200.

The series of processing explained above can be executed by hardware or can be executed by software or a combination of hardware and software.

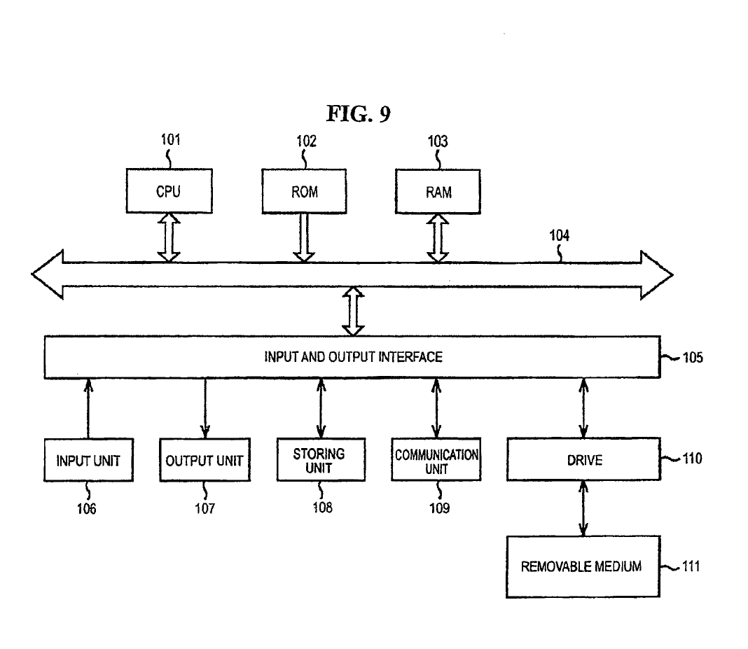

The configurations disclosed below with reference to FIG. 9 may correspond to any one or more of the client terminal 10, the server terminal 20, the distributed server terminal 30, the NAS 100, the NAS 200 and/or the NAS 300. It should be noted that the configuration of these components is by no means limited to that shown in FIG. 9, which serves as merely an exemplary hardware configuration of these devices.

In FIG. 9, a CPU 101 executes various kinds of processing according to a program recorded in a ROM (Read Only Memory) 102 or a program loaded from a storing unit 108 to a RAM (Random Access Memory) 103. Data and the like necessary when the CPU 101 executes the various kinds of processing are also stored in the RAM 103 as appropriate. Processing performed by the CPU 101 of the server terminal 20 may include the functions of one or more of the physical layer function unit 21, the client-side general functional unit 22, the client side specific functional unit 23, the server side specific functional unit 24, and the server side general functional unit 25. It should be noted that more than one processors may exist in the server terminal 20 to perform selected functions of the functional units outlined above.

The CPU 101, the ROM 102, and the RAM 103 are connected to one another via a bus 104. An input and output interface 105 is also connected to the bus 104.

An input unit 106 including a keyboard and a mouse, an output unit 107, a storing unit 108 including a hard disk, and a communication unit 109 including a modem and a terminal adapter are connected to the input and output interface 105. The communication unit 109 controls communication performed between the personal computer and another apparatus (not shown) via a network including the Internet.

A drive 110 is also connected to the input and output interface 105 when necessary. A removable medium 111 such as a magnetic disk, an optical disk, a magneto-optical disk, or a semiconductor memory is inserted in the drive 110 as appropriate. A computer program read out from the removable medium 111 is installed in the storing unit 108 when necessary.

When the series of processing is executed by the software, a program forming the software is installed from a network or a recording medium in a computer incorporated in dedicated hardware or a general-purpose personal computer or the like that can execute various functions by installing various programs.

A recording medium including such a program is not limited to the removable medium (a package medium) 111 such as a magnetic disk (including a floppy disk), an optical disk (a CD-ROM (Compact Disk-Read Only Memory) and a DVD (Digital Versatile Disk)), a magneto-optical disk (including an MD (Mini-Disk)), or a semiconductor memory that is distributed to provide the user with the program separately from an apparatus main body as shown in FIG. 9. The recording medium may be a hard disk, the ROM 102 or the storing unit 108 shown in FIG. 9 that is provided to the user while being incorporated in an apparatus main body in advance and in which the program is recorded.

In this specification, steps of describing the program recorded in the recording medium include not only processing performed in time series according to order of the steps but also processing in parallel or individually, although not always processed in time series.

### Other Embodiments

Although the present disclosure has been described with reference to the embodiment described above, it should not be understood that the discussion and drawings constituting a part of the disclosure are limiting the present invention. Various alternative embodiments, examples and operation technologies, which are not disclosed in the present disclosure, may be thought by a person skilled in the art from the present disclosure.

Although the embodiment described above, an example of the network device is the server terminal 20; however, the embodiment is not limited thereto. For example, the network device may be a terminal, such as a personal computer. Alternatively, the network device may not be provided with a database, such as hard disk.

What is claimed is:

1. A network device, comprising:
a hardware section that executes functions of
a server-side specific functional unit which has a function to manage a location of a data file in accordance with a specific file sharing function;
a client-side specific functional unit which has a function to acquire the data file in accordance with the specific file sharing function;
a server-side general functional unit which has a function to manage the location of the data file in accordance with a general file sharing function; and
a client-side general functional unit which has a function to acquire the data file in accordance with the general file sharing function, wherein
the server-side general functional unit requests the client-side general functional unit to acquire the data file via the server-side specific functional unit and the client-side specific functional unit,
the client-side general functional unit acquires the data file requested by the server-side general functional unit from another network device, and
the server-side specific functional unit and the client-side specific functional unit are connected by a virtual network established inside the network device.

2. The network device according to claim 1, wherein a virtual network address used within the network device is allocated to the server-side specific functional unit and the client-side specific functional unit to establish the virtual network.

3. The network device according to claim 1, wherein the server-side general functional unit requests the client-side general functional unit to acquire the data file via the server-side specific functional unit and the client-side specific functional unit, if the another network device does not have the specific file sharing function.

4. The network device according to claim 1, wherein:
the server-side general functional unit inquires of the server-side specific functional unit about a location of the data file if the another network device has the specific file sharing function,
the server-side specific functional unit requests the client-side specific functional unit to acquire the data file requested by the server-side general functional unit, and
the client-side specific functional unit acquires the data file requested by the server-side general functional unit, from the another network device.

5. The network device according to claim 1, wherein
the data file shared with the specific file sharing function or the general file sharing function is fragmented and stored in multiple other network devices, and
real addresses of the data file fragmented and stored in the multiple other network devices are correlated with a local address used within the network device.

6. A file transfer method performed by a network device that includes a hardware section that functions as a server-side specific functional unit which has a function to manage a location of data file in accordance with a specific file sharing function, a client-side specific functional unit which has a function to acquire the data file in accordance with the specific file sharing function, a server-side general functional unit which has a function to manage the location of the data file in accordance with a general file sharing function, and a client-side general functional unit which has a function to acquire data file in accordance with the general file sharing function, the file transfer method comprising the steps of:
requesting the client-side general functional unit to acquire data file from the server-side general functional unit via the server-side specific functional unit and the client-side specific functional unit;
transmitting the data file requested by the server-side general functional unit, from another network device to the client-side general functional unit; and
transmitting the data file received from the another network device, from the client-side general functional unit to the server-side general functional unit; wherein
the server-side specific functional unit and the client-side specific functional unit are connected to each other by a virtual network established inside the network device.

7. A non-transitory computer readable medium including computer program instructions, which when executed by a network device, cause the network device to function as:
a server-side specific functional unit which has a function to manage a location of a data file in accordance with a specific file sharing function;
a client-side specific functional unit which has a function to acquire the data file in accordance with the specific file sharing function;
a server-side general functional unit which has a function to manage the location of the data file in accordance with a general file sharing function; and
a client-side general functional unit which has a function to acquire the data file in accordance with the general file sharing function, wherein
the server-side general functional unit requests the client-side general functional unit to acquire the data file via the server-side specific functional unit and the client-side specific functional unit,
the client-side general functional unit acquires the data file requested by the server-side general functional unit from another network device, and
the server-side specific functional unit and the client-side specific functional unit are connected by a virtual network established inside the network device.
